(19) United States
(12) Patent Application Publication
(10) Pub. No.: US 2011/0035779 A1
(43) Pub. Date: Feb. 10, 2011

(54) SET-TOP BOX AND METHOD FOR DISPLAYING CONTENT THEREON

(75) Inventors: JUAN-JUAN GONG, Shenzhen City (CN); YAN-ZHI WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/582,803

(22) Filed: Oct. 21, 2009

(30) Foreign Application Priority Data
Aug. 6, 2009 (CN) 200910305285.9

(51) Int. Cl. H04N 7/173

(52) U.S. Cl. 725/100; 725/101

(57) ABSTRACT

A method for displaying near video on demand (NVOD) content on a set-top box (STB) includes determining whether the processor is idle, and connecting to a video server for storing NVOD data, if the processor is determined to be idle. If a NVOD request is received from a user, the NVOD data is parsed according to the NVOD request and displayed via a NOVD interface.

### BACKGROUND

1. Technical Field

Embodiments of the present disclosure relate to set-top boxes (STBs), and especially to an STB and method for displaying near video on demand (NVOD) thereon.

2. Description of Related Art

Near video on demand (NVOD) service is gaining popularity with set-top box (STB) users. In a common model of NVOD service, the STB receives a NVOD request, and issues a request to a video server, then searches, parses, and stores NVOD data received from the video server. After the NVOD data is prepared, accessing a NVOD interface permits display of the NVOD content.

However, this model requires unreasonably heavy utilization of a processor of the STB, long waits for data completion, and the necessity for large memory space.

### BRIEF DESCRIPTION OF THE DRAWINGS

FIG. 1 is a block diagram of one embodiment of a set-top box (STB) and an application environment utilized therein according to the present disclosure; and

FIG. 2 is a flowchart of one exemplary embodiment of a method for displaying near video on demand (NVOD) on an STB, such as, for example, that of FIG. 1, according to the present disclosure.

### DETAILED DESCRIPTION

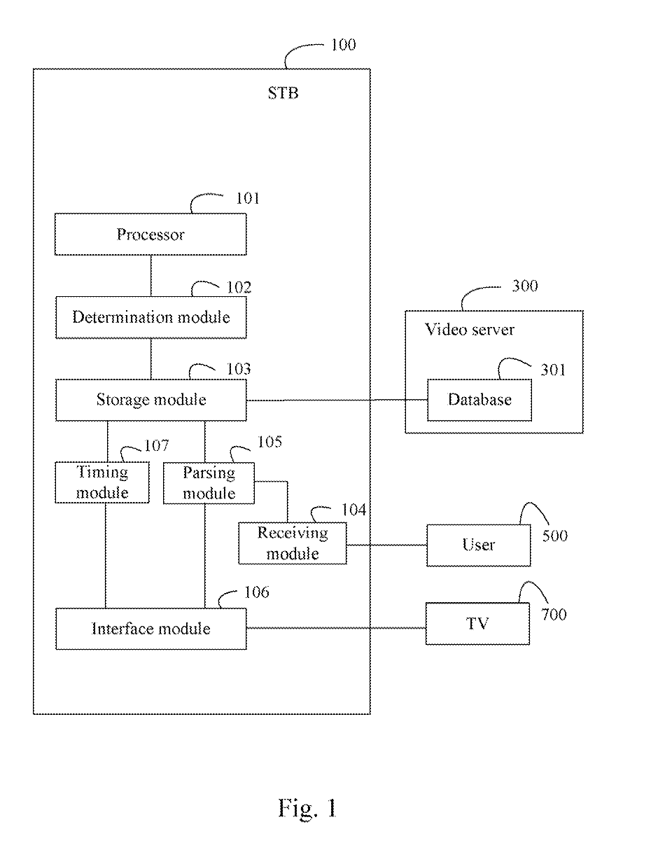

Referring to FIG. 1, a block diagram of one embodiment of a set-top box (STB) 100 and an application environment utilized therein, shows the STB 100 connected to a database 301 of a video server 300, for displaying near video on demand (NVOD). The STB 100 comprises a processor 101, a determination module 102, a storage module 103, a receiving module 104, a parsing module 105, an interface module 106 and a timing module 107.

The processor 101 is operable to control and process tasks on the STB 100.

The determination module 102 is operable to determine whether the processor 101 is idle. In one embodiment, idle condition of the processor 101 is determined as the usage rate of the processor 101 falling below a minimum value. For example, if the usage rate of the processor 101 reaches 25% when the minimum value is preset to be 30%, the determination module 102 determines the processor 101 to be idle.

The storage module 103 is connected to the video server 300 and the determination module 102. The storage module 103 reads and stores NVOD data from the database 301 of the video server 300, when the determination module 102 determines the processor 101 to be idle. In one embodiment, the NVOD data comprises a NVOD event and a NVOD time. For example, the NVOD event may be a CCTV news, and the NOVD time may be 19:00-19:30.

The receiving module 104 is operable to receive a NVOD request and a quit request from a user 500. In one example, the user may send the NVOD request and the quit request by a remote controller using infrared ray technology. Accordingly, the receiving module 104 is operable to receive the NVOD request and quit request over the infrared spectrum.

In one embodiment, the storage module 103 connects to the database 301 of the video server 300 to read and store NVOD data requested by a user 500, when the NVOD request comprises NVOD data not currently stored in the storage module 103.

The parsing module 105 is connected to the receiving module 104 and the storage module 103, operable to parse the NVOD data according to the NVOD request, and output parsed NVOD content to the interface module 106.

The interface module 106 is operable to receive the parsed NVOD content and launch a NVOD interface to display the parsed NVOD content. In one embodiment, the interface module 106 of the STB 100 may be connected to a display, such as a TV 700, to display the parsed NVOD content on the TV 700.

The timing module 107 is operable to time a continuous display time of the interface module 106, and determine whether the continuous display time exceeds a preset time value. In one embodiment, the continuous display time is the continuous display time for one program, for example 60 minutes. The preset time value is an average value of programs. As an example, entertainment programs usually last about 40 minutes, most dramas last about 45 minutes, and news programs last about 30 minutes, providing a preset time of 38.3 minutes according to the average value of these times. That is, when a program is continuously displayed longer than 38.3 minutes, the storage module 103 can release the NVOD data, to begin storing new NVOD data.

The timing module 107 is further operable to issue a release request to the storage module 103, if the continuous display time exceeds the preset time value.

The storage module 103 is further operable to release the NVOD data after receiving the release request from the timing module 107 or the quit request from the receiving module 104.

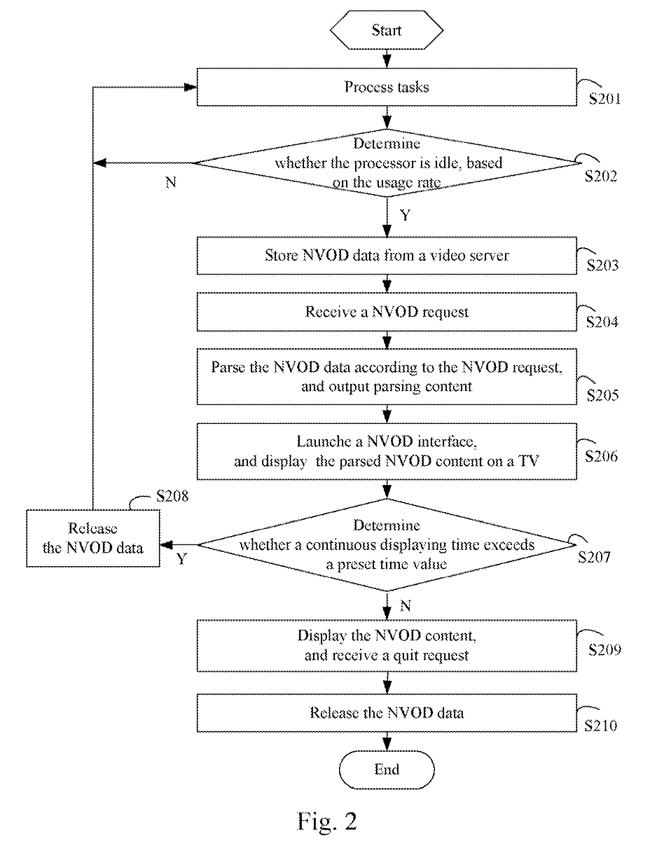

Referring to FIG. 2, a flowchart of one exemplary embodiment of a method for displaying NVOD of a STB 100 is shown. Upon booting up the STB 100, block S201 is implemented, where a processor 101 processes tasks on the STB 100.

In block S202, a determination module 102 determines whether the processor 101 is idle, based on the usage rate of the processor 101. For example, if a minimum usage rate value is preset to be 30%, when the usage rate of the processor 101 reaches 29%, the determination module 102 determines the processor 101 to be idle, in which case block S203 is implemented, and if not, block S201 is repeated.

In block S203, a storage module 103 connects to a video server 300, operable to read and store NVOD data received from a database 301 of the video server 300. In one embodiment, the NVOD data comprises a NVOD event and a NVOD time.

In block S204, a receiving module 104 receives a NVOD request from a user 500. In one embodiment, the NVOD request may comprise a NVOD display request, a NVOD search channel request, for example.

In block S205, a parsing module 105 parses the NVOD data according to the NVOD request, and outputs parsed NVOD content.

In block S206, an interface module 106 launches a NVOD interface, and displays the parsed NVOD content.

In block S207, a timing module 107 determines whether a continuous display time of the interface module 106 exceeds a preset time value. If the continuous display time exceeds the preset time value, block S208 is implemented, and block S209 is implemented, if the continuous playing time does not exceeds the preset time value.

In block S208, the storage module 103 releases the NVOD data, and block S201 is repeated to await processor 101 entering an idle state.

In block S209, the interface module 106 displays the NVOD, and the receiving module 104 receives a quit request.

In block S210, the storage module 103 releases the NVOD data and the STB 100 finishes displaying the NVOD.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A method for displaying near video on demand (NVOD) content on a set-top box (STB), the STB comprising a determination module, a storage module, a receiving module, a parsing module, an interface module, and a processor, the method comprising:
the determination module determining whether the processor is idle;
the storage module connecting to a video server for storing NVOD data if the processor is idle, wherein the NVOD data comprises a NVOD event and a NVOD time;
the receiving module receiving a NVOD request from a user;
the parsing module parsing the NVOD data according to the NVOD request, and outputting parsed NVOD content; and
the interface module launching a NOVD interface, and displaying the parsed NVOD content onto a display.

2. The method as claimed in claim 1, wherein the processor is determined to be idle when the usage rate of the processor falls below a minimum value.

3. The method as claimed in claim 1, wherein the receiving module further receives a quit request from the user, and the storage module releases the NVOD data accordingly.

4. The method as claimed in claim 3, further comprising a timing module comparing whether a continuous display time of the interface module exceeds a preset time value, and if the continues display time exceeds the preset time value, the storage module releases the NVOD data.

5. A set-top box (STB), connected to a video server, for displaying near video on demand (NVOD) content, the STB comprising:
a processor operable to control and process tasks on the STB;
a determination module operable to determine whether the processor is idle; and
a storage module connecting to the video server if the processor is determined to be idle, operable to store NVOD data, wherein the NVOD data comprises a NVOD event and a NVOD time;
a receiving module operable to receive a NVOD request and a quit request;
a parsing module operable to parse the NVOD data according to the NVOD request, and output parsed NVOD content; and
an interface module connecting to the parsing module, and operable to launch a NVOD interface and display the parsed NVOD content onto a display.

6. The STB as claimed in claim 5, wherein the processor is determined to be idle when the usage rate of the processor falls below a minimum value.

7. The STB as claimed in claim 5, further comprising a timing module, operable to compare whether a continuous display time of the interface module exceeds a preset time value.

8. The STB as claimed in claim 7, wherein the timing module is further operable to issue a release request to the storage module, if the continues display time exceeds the preset time value.

9. The STB as claimed in claim 8, wherein the storage module is further operable to release the NVOD data, upon receiving the release request from the timing module or the quit request from the receiving module.
